(19) United States
(12) Patent Application Publication
(10) Pub. No.: US 2018/0371273 A1
(43) Pub. Date: Dec. 27, 2018

(54) Water-Based Ink for Ink-Jet Recording and Ink-Jet Recording Method

(71) Applicant: Brother Kogyo Kabushiki Kaisha, Nagoya-shi (JP)

(72) Inventor: Miki Nishiura, Toyoake-shi (JP)

(21) Appl. No.: 15/933,772

(22) Filed: Mar. 23, 2018

(30) Foreign Application Priority Data
Jun. 27, 2017 (JP) 2017-125240

(51) Int. Cl. C09D 11/322; C09D 11/326

(52) U.S. Cl. CPC C09D 11/322; B41M 7/009; C09D 11/326

(57) ABSTRACT

A water-based ink for ink-jet recording includes: a resin-dispersed pigment; emulsion particles of a vinyl chloride-acrylic copolymer of which glass transition temperature is equal to or more than 50° C.; methacrylic acid ions; and water. A ratio (A/E) of a blending amount (A) of the methacrylic acid ions to a solid content blending amount (E) of the emulsion particles of the vinyl chloride-acrylic copolymer in the water-based ink is equal to or more than 0.01.

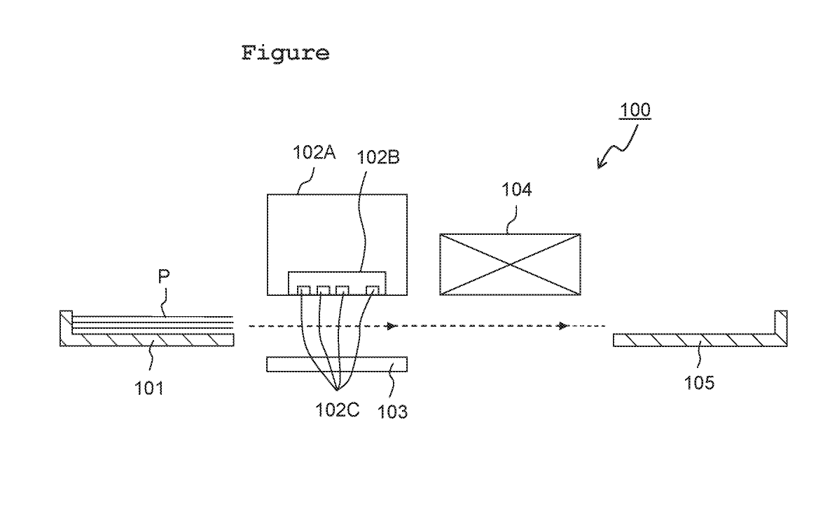

### CROSS REFERENCE TO RELATED APPLICATION

The present application claims priority from Japanese Patent Application No. 2017-125240 filed on Jun. 27, 2017, the disclosure of which is incorporated herein by reference in its entirety.

### BACKGROUND OF THE INVENTION

### Field of the Invention

The present invention is related to a water-based ink for inkjet recording and an ink-jet recording method.

### Description of the Related Art

There is suggested a water-based ink containing a vinyl chloride-acrylic copolymer, as a water-based ink for ink-jet recording having great fixing performance onto coated paper (Japanese Patent Application Laid-open No. 2014-19811).

In order to fix the water-based ink containing the vinyl chloride-acrylic copolymer to the coated paper, the water-based ink is required to be heated and dried under high temperature for a long time.

In view of the above, an object of the present teaching is to provide a water-based ink for ink-jet recording that can be fixed to coated paper by being dried at a low temperature in a short time.

### SUMMARY OF THE INVENTION

According to a first aspect of the present teaching, there is provided a water-based ink for ink-jet recording, including: a resin-dispersed pigment; emulsion particles of a vinyl chloride-acrylic copolymer of which glass transition temperature is equal to or more than 50° C.; methacrylic acid ions; and water, wherein a ratio (A/E) of a blending amount (A) of the methacrylic acid ions to a solid content blending amount (E) of the emulsion particles of the vinyl chloride-acrylic copolymer in the water-based ink is equal to or more than 0.01.

According to a second aspect of the present teaching, there is provided an ink-jet recording method, including: performing recording by jetting the water-based ink of the first aspect of the present teaching onto a recording medium in accordance with an ink-jet system; and heating a portion recorded by use of the water-based ink on the recording medium at a temperature in a range of 0.2 to 4 times of the glass transition temperature of the vinyl chloride-acrylic copolymer to fix the water-based ink to the recording medium.

### BRIEF DESCRIPTION OF THE DRAWINGS

FIGURE schematically depicts an exemplary structure of an ink-jet recording apparatus of the present teaching.

### DESCRIPTION OF THE EMBODIMENTS

In the present teaching, “coated paper” is paper obtained by coating regular paper mainly made from pulp, such as high-grade print paper and middle-grade print paper, with a coating agent. The coating agent is applied to the regular paper to improve its smoothness, whiteness, brightness, and the like. The coated paper is exemplified by high-grade coated paper, middle-grade coated paper, and the like. A water-based ink for ink-jet recording of the present teaching (hereinafter also referred to as “a water-based ink” or “an ink”) and an ink-jet recording method of the present teaching can be preferably used for ink-jet recording on the coated paper. The present teaching, however, is not limited thereto. In addition to the coated paper, the present teaching is applicable to ink-jet recording on any other recording medium, such as regular paper, glossy paper, and mat paper.

The water-based ink of the present teaching is explained. The water-based ink of the present teaching contains colorant and water.

The colorant contains a resin-dispersed pigment (resin-dispersible pigment, resin dispersion type pigment). The resin-dispersed pigment is dispersible in water by, for example, a pigment dispersing resin (resin dispersant). The resin-dispersed pigment is not particularly limited, which is exemplified, for example, by carbon black, an inorganic pigment, and an organic pigment. The carbon black is exemplified, for example, by furnace black, lamp black, acetylene black, and channel black. The inorganic pigment is exemplified, for example, by titanium oxide, iron oxide-based inorganic pigments, and carbon black-based inorganic pigments. The organic pigment is exemplified, for example, by azo-pigments such as azo lake, insoluble azo-pigment, condensed azo-pigment, and chelate azo-pigment; polycyclic pigments such as phthalocyanine pigment, perylene and perynon pigments, anthraquinone pigment, quinacridone pigment, dioxadine pigment, thioindigo pigment, isoindolinone pigment, and quinophthalone pigment; dye lake pigments such as basic dye type lake pigment and acid dye type lake pigment; nitro pigments; nitroso pigments; and aniline black daylight fluorescent pigment. Besides the above-listed examples, the resin-dispersed pigment can be exemplified, for example, by C. I. Pigment Blacks 1, 6, and 7; C. I. Pigment Yellows 1, 2, 3, 12, 13, 14, 15, 16, 17, 55, 74, 78, 150, 151, 154, 180, 185, and 194; C. I. Pigment Oranges 31 and 43; C. I. Pigment Reds 2, 3, 5, 6, 7, 12, 15, 16, 48, 48:1, 53:1, 57, 57:1, 112, 122, 123, 139, 144, 146, 149, 150, 166, 168, 175, 176, 177, 178, 184, 185, 190, 202, 209, 221, 222, 224, and 238; C. I. Pigment Violets 19 and 196; C. I. Pigment Blues 1, 2, 3, 15, 15:1, 15:2, 15:3, 15:4, 16, 22, and 60; C. I. Pigment Greens 7 and 36; and solid solutions of the above-listed pigments.

The resin dispersant is exemplified, for example, by that containing at least one of methacrylic acid and acrylic acid as a monomer. The resin dispersant may be, for example, a commercially available product. The resin dispersant may further contain, for example, styrene and vinyl chloride as a monomer. Examples of the commercially available product include “JOHNCRYL (trade name) 611” (weight-average molecular weight: 8,100, acid value: 53 mgKOH/g), “JOHNCRYL (trade name) 60” (weight-average molecular weight: 8,500, acid value: 215 mgKOH/g), “JOHNCRYL (trade name) 586”, “JOHNCRYL (trade name) 687”, “JOHNCRYL (trade name) 63” and “JOHNCRYL (trade name) HPD296” produced by BASF Corporation (the former Johnson Polymer L.L.C.); “Disperbyk 190” and “Disperbyk 191” produced by BYK additives & Instruments; and “SOLSPERSE 20000” and “SOLSPERSE 27000” produced by Zeneca.

The solid content blending amount of the resin-dispersed pigment (pigment solid content amount) in the entire amount of the water-based ink is not particularly limited, and it may be appropriately determined based on a desired optical density, chromaticness, and the like. The pigment solid content amount is, for example, in a range of 0.1 to 20% by weight, in a range of 1 to 15% by weight, or in a range of 2 to 10% by weight. The pigment solid content amount indicates the weight of only the pigment, namely, it does not include the weight of the resin dispersant. Only one kind of the resin-dispersed pigment as described above may be used singly, or two or more kinds of the resin-dispersed pigments may be used in combination.

The blending amount of the pigment dispersing resin (resin dispersant) in the entire amount of the ink is not particularly limited, and it may be appropriately determined based on the kind of the resin-dispersed pigment, the pigment solid content amount, and the like. The ratio of the solid content weight of the resin dispersant to the solid content weight of the resin-dispersed pigment in the water-based ink is, for example, in a range of 5 to 100% by weight or in a range of 10 to 50% by weight.

Besides the resin-dispersed pigment, the water-based ink may or may not further contain any other colorant, such as a pigment and a dye. In order to improve the fixing performance to the coated paper, the main component of the colorant(s) is preferably the resin-dispersed pigment. The ratio of the blending amount of the resin-dispersed pigment to the total blending amount of the colorant(s) is, for example, in a range of 95 to 100% by weight or in a range of 98 to 100% by weight.

The water is preferably ion-exchanged water or pure water (purified water). The blending amount of the water in the entire amount of the water-based ink may be, for example, a balance of the other components.

The water-based ink further contains a vinyl chloride-acrylic copolymer emulsion and methacrylic acid ions.

The vinyl chloride-acrylic copolymer emulsion is a system in which emulsified particles of the vinyl chloride-acrylic copolymer are dispersed in water (water may contain a hydrophilic solvent). Here, the particles of the vinyl chloride-acrylic copolymer in the vinyl chloride-acrylic copolymer emulsion are described as “emulsion particles (emulsified particles) of the vinyl chloride-acrylic copolymer” or simply described as “emulsion particles (emulsified particles)”. Namely, the water-based ink contains the emulsion particles of the vinyl chloride-acrylic copolymer.

The glass transition temperature (Tg) of the vinyl chloride-acrylic copolymer forming the emulsion particles is equal to or more than 50° C. When the glass transition temperature (Tg) is less than 50° C., a film of the vinyl chloride-acrylic copolymer emulsion may be formed in the water-based ink before ink jetting, which may cause jetting failure and reduce the fixing performance to the coated paper. For the purpose of drying the recording medium (the coated paper) at relatively low drying temperature in a fixing step as described below, the glass transition temperature (Tg) is, for example, preferably equal to or less than 200° C. The glass transition temperature (Tg) is, for example, in a range of 57 to 73° C.

The vinyl chloride-acrylic copolymer emulsion may be prepared privately or independently. The vinyl chloride-acrylic copolymer emulsion may be, for example, a commercially available product. The vinyl chloride-acrylic copolymer emulsion may be, for example, a core-shell type emulsion. The core-shell type emulsion is exemplified, for example, by that in which the core of each emulsion particle is polymeric and the shell of each emulsion particle is a surfactant or an emulsifier. The core-shell type emulsion, however, is not limited thereto. The core-shell type emulsion can be prepared, for example, by any well-known method such as emulsion polymerization using a surfactant and emulsion polymerization in the presence of a polymer emulsifier prepared in advance. The polymer emulsifier forms a shell that is an outer layer of each emulsion particle and a copolymer formed in a subsequent process forms a core that is an inner layer of each emulsion particle. The core-shell type emulsion may be prepared, for example, by any other method than the emulsion polymerization, such as radical polymerization reaction. Examples of the commercially available product include “VINYBLAN (trade name) 700” (Tg: 70° C., active ingredient concentration: 30% by weight), “VINYBLAN (trade name) 701” (Tg: 73° C., active ingredient concentration: 30% by weight), and “VINYBLAN (trade name) 745” (Tg: 57° C., active ingredient concentration: 30% by weight) produced by Nissin Chemical Industry Co., Ltd.

The methacrylic acid ions may be added to the water-based ink, as salts formed with cations such as potassium ions. Namely, the methacrylic acid ions may be methacrylic acid ions derived from potassium methacrylate, and the water-based ink may contain potassium ions.

The solid content blending amount (E) of the vinyl chloride-acrylic copolymer emulsion and the blending amount (A) of the methacrylic acid ions in the entire amount of the water-based ink satisfy A/E≥0.01. In order to improve the resistance to water, the solid content blending amount (E) and the blending amount (A) preferably satisfy A/E=0.01 to 0.16, more preferably satisfy A/E=0.01 to 0.1. The solid content blending amount (E) of the vinyl chloride-acrylic copolymer emulsion indicates a solid content blending amount of emulsion particles in the entire amount of the water-based ink.

The solid content blending amount (E) and the blending amount (A) may be adjusted as appropriate to satisfy A/E≥0.01. For example, the solid content blending amount (E) is in a range of 0.1 to 10% by weight, in a range of 1 to 8% by weight, or in a range of 3 to 6% by weight. The blending amount (A) is, for example, in a range of 0.001 to 0.1% by weight, in a range of 0.01 to 0.08% by weight, or in a range of 0.03 to 0.06% by weight. Or, the blending amount (A) may be, for example, in a range of 0.05 to 1.0% by weight or in a range of 0.05 to 0.5% by weight.

The water-based ink which contains the emulsion particles of the vinyl chloride-acrylic copolymer of which glass transition temperature (Tg) is equal to or more than 50° C. as well as a predefined amount of methacrylic acid ions can be fixed to the coated paper by being dried at a low temperature and in a short time. The mechanism improving the fixing performance to the coated paper is assumed, for example, as follows. Namely, the methacrylic acid ions added to the water-based ink approach acrylic portions that are hydrophilic portions of the emulsion partciles in the vinyl chloride-acrylic copolymer emulsion, which makes a dispersion state of the emulsion unstable. Thus, the water-based ink can be fixed to the coated paper by being dried at a low temperature and in a short time. This mechanism, however, is just an assumption and the present teaching is not limited thereto. The drying temperature is explained in an inkjet recording method of the present teaching described below.

The water-based ink may further contain propylene glycol (PG). The propylene glycol may function as a humectant that prevents the water-based ink from drying at an end of a nozzle in an ink-jet head. The blending amount (P) of the propylene glycol and the solid content blending amount (E) of the vinyl chloride-acrylic copolymer emulsion in the entire amount of the water-based ink preferably satisfy P/E=2 to 7, more preferably satisfy P/E=2 to 3. When P/E=2 to 7 is satisfied, it is possible to obtain the water-based ink with high resistance to water. When P/E=2 to 3 is satisfied, it is possible to obtain the water-based ink in which the resistance to water and the fixing performance to the coated paper are very good. The blending amount (P) is, for example, in a range of 5 to 50% by weight, in a range of 10 to 35% by weight, or in a range of 15 to 30% by weight. Or, the blending amount (P) may be, for example, in a range of 5 to 35% by weight or in a range of 10 to 15% by weight.

The water-based ink may further contain any other humectant than the propylene glycol. The humectant except for the propylene glycol is not particularly limited, which is exemplified, for example, by lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyvalent alcohols such as alkylene glycol except for the propylene glycol, glycerol, trimethylolpropane, and trimethylolethane; 2-pyrrolidone; N-methyl-2-pyrrolidone; and 1,3-dimethyl-2-imidazolidinone. The polyalkylene glycol is exemplified, for example, by polyethylene glycol and polypropylene glycol. The alkylene glycol except for the propylene glycol is exemplified, for example, by ethylene glycol, butylene glycol, diethylene glycol, triethylene glycol, dipropylene glycol, tripropylene glycol, thiodiglycol, and hexylene glycol. Only one kind of the humectant as described above except for the propylene glycol may be used singly, or two or more kinds of the humectants except for the propylene glycol may be used in combination. Among the above, the polyvalent alcohols, such as the alkylene glycol except for the propylene glycol and the glycerol, are preferably used.

The blending amount of the humectant(s) except for the propylene glycol in the entire amount of the water-based ink is, for example, in a range of 0 to 95% by weight, in a range of 5 to 80% by weight, or in a range of 5 to 50% by weight.

The water-based ink may not contain any other humectant(s) than the propylene glycol. For example, the water-based ink may not contain any other polyvalent alcohol(s) than the propylene glycol. Even when the water-based ink contains the polyvalent alcohol(s), such as the alkylene glycol except for the propylene glycol and the glycerol, the main component of the humectants is preferably the propylene glycol to improve the resistance to water and the fixing performance to the coated paper. The ratio of the blending amount of the propylene glycol to the total blending amount of the polyvalent alcohol(s) in the water-based ink is, for example, in a range of 95 to 100% by weight or in a range of 98 to 100% by weight.

The water-based ink may further contain a penetrant. The penetrant adjusts, for example, the drying velocity on a recording medium.

The penetrant is exemplified, for example, by glycol ether. The glycol ether is exemplified, for example, by ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. Only one kind of the penetrant as described above may be used singly, or two or more kinds of the penetrants may be used in combination.

The blending amount of the penetrant in the entire amount of the water-based ink is, for example, in a range of 0 to 20% by weight, in a range of 0 to 15% by weight, or in a range of 1 to 6% by weight.

The water-based ink may further contain a conventionally known additive, as necessary. The additive is exemplified, for example, by surfactants, pH-adjusting agents, viscosity-adjusting agents, surface tension-adjusting agents, and fungicides. The viscosity-adjusting agents are exemplified, for example, by polyvinyl alcohol and cellulose.

The water-based ink may be prepared, for example, by mixing the resin-dispersed pigment, the water, the vinyl chloride-acrylic copolymer emulsion, the methacrylic acid ions, and optionally other additive component(s) as necessary uniformly or homogeneously through any conventionally known method and then removing undissolved matters by a filter or the like.

As described above, the water-based ink for ink-jet recording of the present teaching which contains the vinyl chloride-acrylic copolymer emulsion of which glass transition temperature is in a predefined range as well as a predefined amount of the methacrylic acid ions can be fixed to the coated paper by being dried at a low temperature in a short time.

Next, an ink-jet recording apparatus and an ink-jet recording method of the present teaching are explained.

The ink-jet recording apparatus of the present teaching is an ink-jet recording apparatus characterized by including: an ink accommodating section accommodating an ink therein; an ink-jetting mechanism configured to jet the ink accommodated in the ink accommodating section; and a drying mechanism configured to heat and dry a recording portion formed by using the ink, wherein the ink accommodated in the ink accommodating section is the water-based ink for ink-jet recording of the present teaching.

The ink-jet recording method of the present teaching is characterized by including: a recording step of performing recording by jetting a water-based ink onto a recording medium in accordance with an ink-jet system and a fixing step of fixing the water-based ink to the recording medium by use of a drying mechanism configured to heat and dry a recording portion of the recording medium, wherein the water-based ink for ink-jet recording of the present teaching is used as the water-based ink in the recording step, and a heating temperature in the fixing step is a temperature in a range of 0.2 to 4 times of the glass transition temperature of the vinyl chloride-acrylic copolymer.

The ink-jet recording method of the present teaching can be performed, for example, by using the ink-jet recording apparatus of the present teaching. The recording includes printing a letter (text), printing an image, printing, etc.

The FIGURE schematically depicts an exemplary configuration of the ink-jet recording apparatus of the present teaching. As depicted in the FIGURE, an ink-jet recording apparatus 100 includes a feed tray 101, a conveyance mechanism (not depicted) such as a roller, recording mechanisms 102A and 102B, a platen 103, a drying mechanism 104, a discharge tray 105, and ink cartridges or ink accommodating sections (not depicted) such as ink tanks. The feed tray 101 can support recording mediums (e.g., pieces of coated paper) stacked thereon.

A conveyance route (not depicted) by use of a guide member is formed in the ink-jet recording apparatus 100. As indicated by a broken line in the FIGURE, the recording medium P is conveyed from the feed tray 101 to the discharge tray 105 by use of the conveyance mechanism and the conveyance route.

The recording mechanism includes a carriage 102A and an ink-jet head (ink jetting mechanism) 102B. The carriage 102A is supported by two guide rails (not depicted) extending vertically to a conveyance direction of the recording medium P. The two guide rails are supported by a casing (not depicted) of the ink-jet recording apparatus 100. The carriage 102B is connected to a well known belt mechanism (not depicted) provided in the two guide rails. The belt mechanism is driven by a carriage motor (not depicted). The carriage motor is driven to reciprocatingly move the carriage 102A connected to the belt mechanism in a vertical direction with respect to the conveyance direction of the recording medium P.

Further, four ink tubes (not depicted) connecting the ink accommodating sections and the ink-jet head 102B and a flexible fiat cable (not depicted) electrically connecting a control board (a controller, not depicted) and the ink-jet head 102B extend from the carriage 102A. Four colors of water-based inks (yellow, magenta, cyan, and black) accommodated in the ink accommodating sections are supplied to the ink-jet head 102B via the four ink tubes. At least one of the four water-based inks is the water-based ink for ink-jet recording of the present teaching. A control signal output from the control board is transmitted to the ink-jet head 102B via the flexible flat cable.

As depicted in the FIGURE, the carriage 102A carries the ink-jet head 102B. Nozzles 102C are formed in a lower surface of the ink-jet head 102B. A front end of each nozzle 102C is exposed from the carriage 102A and the lower surface of the ink-jet head 102B. The ink-jet head 102B includes an actuator (not depicted) applying force to jet the water-based ink, which is supplied from the ink accommodating section to the ink-jet head 102B via the ink tube. The actuator may be an actuator of any system, such as a piezoelectric element system, a thermal ink-jet system, and an electrostatic attraction system. The ink-jet head 102B jets fine ink droplets of the water-based ink from the nozzles 102C during a process in which the carriage 102A reciprocates in the vertical direction with respect to the conveyance direction of the recording sheet P. Accordingly, an image is recorded on the recording medium P. The platen 103 is disposed to face the recording mechanism and supports the recording medium P conveyed from the feed tray 101.

The drying mechanism 104 heats and dries a recording portion of the recording medium P. The drying temperature is a temperature in a range of 0.2 to 4 times of the glass transition temperature of the vinyl chloride-acrylic copolymer. The drying temperature may be a temperature in a range of 0.2 to 2 times or 0.2 to 1 times of the glass transition temperature of the vinyl chloride-acrylic copolymer. The drying temperature may be appropriately adjusted by changing the settings of the drying mechanism 104. Specifically, the drying temperature may be in a range of 20 to 200° C. or in a range of 50 to 100° C. The drying time may be also adjusted as appropriate by changing the settings of the drying mechanism 104. For example, the drying time may be in a range of a second(s) exceeding 0 to equal to less than 300 seconds, in a range of 0.1 to 60 seconds, or in a range of 30 to 60 seconds. The water-based ink of the present teaching can be fixed to the coated paper at a lower temperature and in a shorter time than conventional water-based inks requiring heating and drying at a high temperature and for a long time. The drying mechanism 104 may be any mechanism that can dry the recording portion. The recording portion may be dried by blowing, by heating or by a combination of blowing and heating. Examples of the drying mechanism 104 include heating mechanisms such as IR heater, ovens, belt conveyer ovens, irons, and hot presses, and heating and blowing mechanisms such as commercially available driers. A non-contact drying mechanism, such as the drier, the oven, and the belt conveyer oven, which heats and dries a recording portion of the recording medium P without contacting with the recording portion is preferably used.

The recording medium P after recording and drying is conveyed to the discharge tray 105.

### EXAMPLES

Next, Examples of the present teaching are explained together with Comparative Examples. Note that the present teaching is not limited to and restricted by Examples and Comparative Examples described below.

<Preparation of Pigment Dispersion Liquids A and B>

Purified water was added to 20% by weight of a pigment (carbon black) and 7% by weight of a sodium hydroxide neutralized product of a styrene-acrylic acid copolymer (acid value 175 mgKOH/g, molecular weight 10,000), so that the sum of them was 100% by weight, followed by being stirred (agitated) and mixed with each other. This mixture was put in a wet sand mill using zirconia beads with a diameter of 0.3 mm as a medium to perform dispersion treatment for six hours. After that, the zirconia beads were removed by a separator, and the mixture thus obtained was filtrated through a cellulose acetate filter (pore size 3.00 μm). Accordingly, the pigment dispersion liquid A was obtained. The pigment dispersion liquid B was obtained similarly to the pigment dispersion liquid A, except that 9% by weight of a sodium hydroxide neutralized product of a styrene-methacrylic acid copolymer (acid value 175 mgKOH/g, molecular weight 10,000) was used instead of 7% by weight of the sodium hydroxide neutralized product of the styrene-acrylic acid copolymer. Each of the styrene-acrylic acid copolymer and the styrene-methacrylic acid copolymer is a water-soluble polymer commonly used as the pigment dispersant.

### EXAMPLES 1-18 AND COMPARATIVE EXAMPLES 1 TO 8

Ingredients, except for the pigment dispersion liquid A, the pigment dispersion liquid B, or CAB-O-JET (trade name) 300, which were included in Ink composition (Tables 1 and 2) were mixed uniformly or homogeneously; and thus an ink solvent was obtained. Subsequently, the ink solvent was added to the pigment dispersion liquid A, the pigment dispersion B, or CAB-O-JET (trade name) 300 dispersed in water, followed by being mixed uniformly. After that, the obtained mixture was filtrated through a cellulose acetate membrane filter (pore size 3.00 μm) produced by Toyo Roshi Kaisha, Ltd., and thus the water-based ink for ink-jet recording in each of Examples 1 to 18 and Comparative examples 1 to 8 as indicated in Tables 1 and 2 was obtained.

With respect to the water-based inks of Examples 1 to 18, (a) evaluation of fixing performance to coated paper and (b) evaluation of resistance to water were conducted by the following methods. With respect to the water-based inks of Comparative examples 1 to 8, (a) evaluation of fixing performance to coated paper was conducted by the following method.

(a) Evaluation of Fixing Performance to Coated Paper

The water-based ink in each of Examples and Comparative Examples was applied to coated paper (product name: OK Top Coat Plus, produced by Oji Paper Co., Ltd.) by using a bar coater such that its application thickness was 3 μm. Accordingly, an application sample of each of Examples and Comparative Examples was prepared. Then, the application sample was dried at 60° C. for 30 seconds. After that, a surface of the application sample was rubbed by a cotton swab from an application portion of each of the water-based inks to a non-application portion. The rubbing off and stains in the application portion and the non-application portion were visually observed, and the evaluation was performed in accordance with the following evaluation criterion.

<Evaluation of Fixing Performance to Coated Paper and Evaluation Criterion>

AA: No rubbing off was observed in the application portion and no stain was observed in the non-application portion;

A: Although the rubbing off was observed in 15% of the application portion after rubbed, but no stain was observed in the non-application portion;

B: Although the rubbing off was observed in 30% of the application portion after rubbed, but no stain was observed in the non-application portion;

C: The rubbing off was observed in the entire application portion after rubbed, and stains were observed in the non-application portion.

(b) Evaluation to Residence to Water

The surface of the application sample dried in (a) the evaluation of fixing performance to coated paper was rubbed with a cotton swab wet with water from the application portion to the non-application portion. This was repeated until white color that is a ground color of the coated paper appeared. The number of times of this process was evaluated in accordance with the following evaluation criterion.

<Evaluation of Resistance to Water and Evaluation Criterion>

AA: Peeling off was observed in the application portion when the surface of the application sample was rubbed at equal to or more than five times, and the white ground color of the coated paper was observed;

A: Peeling off was observed in the application portion when the surface of the application sample was rubbed at two to four times, and the white ground color of the coated paper was observed;

B: Peeling off was observed in the application portion when the surface of the application sample was rubbed at one time, and the white ground color of the coated paper was observed.

The ink compositions and the evaluation results of Examples 1 to 18 and Comparative Examples 1 to 8 are indicated in Tables 1 and 2.

Table 1 (following)—LEGEND

*1: Water dispersion liquid (containing resin dispersant) of carbon black, the numeral thereof in Table 1 indicates the pigment solid content amount;

*2: Water dispersion liquid (containing resin dispersant) of carbon black, the numeral thereof in Table 1 indicates the pigment solid content amount;

*3; Produced by Nissin Chemical Industry Co., Ltd., the numeral thereof in Table 1 indicates the active ingredient amount (solid content amount);

*4: Produced by Nissin Chemical Industry Co., Ltd., the numeral thereof in Table 1 indicates the active ingredient amount (solid content amount);

*5: Produced by Nissin Chemical Industry Co., Ltd., the numeral thereof in Table 1 indicates the active ingredient amount;

*8: Potassium methacrylate. the numerals thereof in Table 1 each indicate a weight of methacrylic acid ions.

TABLE 1

| | | | | Example | | | | | | | | | |
|---|---|---|---|---|---|---|---|---|---|---|---|---|---|
| | | | | 1 | 2 | 3 | 4 | 5 | 6 | 7 | 8 | 9 | 10 |
| Ink | Colorant | Pigment dispersion liquid A (*1) | | 5.0 | 5.0 | 5.0 | 5.0 | 5.0 | 5.0 | 5.0 | 5.0 | 5.0 | 5.0 |
| com- | | Pigment dispersion liquid B (*2) | | — | — | — | — | — | — | — | — | — | — |
| posi- | Vinyl | | Tg | | | | | | | | | | |
| tion | chloride- | | (° C.) | | | | | | | | | | |
| (% by | acrylic | VINYBLAN | 73 | 5.0 | 5.0 | 5.0 | 5.0 | 5.0 | 5.0 | 5.0 | 5.0 | 5.0 | 5.0 |
| weight) | copolymer | (trade name) | | | | | | | | | | | |
| | emulsion | 701 (*3) | | | | | | | | | | | |
| | (E) | VINYBLAN | 57 | — | — | — | — | — | — | — | — | — | — |
| | | (trade name) | | | | | | | | | | | |
| | | 745 (*4) | | | | | | | | | | | |

| | | | | | | | | | | | |
|---|---|---|---|---|---|---|---|---|---|---|---|
| Humectant | Propylene glycol (P) | 25.0 | 25.0 | 25.0 | 25.0 | 25.0 | 25.0 | 25.0 | 5.0 | 10.0 | 15.0 |
| Penetrant | Triethylene glycol-n-butyl ether | 3.00 | 3.00 | 3.00 | 3.00 | 3.00 | 3.00 | 3.00 | 3.00 | 3.00 | 3.00 |
| Surfactant | Olfine (trade name) E1010 (*5) | 1.00 | 1.00 | 1.00 | 1.00 | 1.00 | 1.00 | 1.00 | 1.00 | 1.00 | 1.00 |
| Acid ion | Methacrylic acid ion (*8) | 0.05 | 0.25 | 0.4 | 0.5 | 0.6 | 0.8 | 1.0 | 0.05 | 0.05 | 0.05 |
| (A) | | | | | | | | | | | |

| | | | | | | | | | | |
|---|---|---|---|---|---|---|---|---|---|---|
| Water | balance | balance | balance | balance | balance | balance | balance | balance | balance | balance |

| | | | | | | | | | | |
|---|---|---|---|---|---|---|---|---|---|---|
| A/E | 0.01 | 0.05 | 0.08 | 0.1 | 0.12 | 0.16 | 0.2 | 0.01 | 0.01 | 0.01 |
| P/E | 5 | 5 | 5 | 5 | 5 | 5 | 5 | 1 | 2 | 3 |
| Fixing performance to coated paper | A | A | A | A | A | A | B | A | AA | AA |
| Resistance to water | AA | AA | AA | AA | A | A | B | A | AA | AA |

| | | | | Example | | | | | | | |
|---|---|---|---|---|---|---|---|---|---|---|---|
| | | | | 11 | 12 | 13 | 14 | 15 | 16 | 17 | 18 |
| Ink | Colorant | Pigment dispersion liquid A (*1) | | 5.0 | 5.0 | 5.0 | 5.0 | 5.0 | 5.0 | 5.0 | — |
| com- | | Pigment dispersion liquid B (*2) | | — | — | — | — | — | — | — | 5.0 |
| posi- | Vinyl | | Tg | | | | | | | | |
| tion | chloride- | | (° C.) | | | | | | | | |
| (% by | acrylic | VINYBLAN | 73 | 5.0 | 5.0 | 5.0 | 5.0 | 5.0 | 5.0 | — | 5.0 |
| weight) | copolymer | (trade name) | | | | | | | | | |
| | emulsion | 701 (*3) | | | | | | | | | |
| | (E) | VINYBLAN | 57 | — | — | — | — | — | — | 5.0 | — |
| | | (trade name) | | | | | | | | | |
| | | 745 (*4) | | | | | | | | | |

| | | | | | | | | | |
|---|---|---|---|---|---|---|---|---|---|
| Humectant | Propylene glycol (P) | 20.0 | 35.0 | 5.0 | 10.0 | 15.0 | 20.0 | 25.0 | 25.0 |
| Penetrant | Triethylene glycol-n-butyl ether | 3.00 | 3.00 | 3.00 | 3.00 | 3.00 | 3.00 | 3.00 | 3.00 |
| Surfactant | Olfine (trade name) E1010 (*5) | 1.00 | 1.00 | 1.00 | 1.00 | 1.00 | 1.00 | 1.00 | 1.00 |
| Acid ion (A) | Methacrylic acid ion (*8) | 0.05 | 0.05 | 0.5 | 0.5 | 0.5 | 0.5 | 0.05 | 0.05 |

| | | | | | | | | |
|---|---|---|---|---|---|---|---|---|
| Water | balance | balance | balance | balance | balance | balance | balance | balance |

| | | | | | | | | |
|---|---|---|---|---|---|---|---|---|
| A/E | 0.01 | 0.01 | 0.1 | 0.1 | 0.1 | 0.1 | 0.01 | 0.01 |
| P/E | 4 | 7 | 1 | 2 | 3 | 4 | 5 | 5 |
| Fixing performance to coated paper | A | B | A | AA | AA | A | A | A |
| Resistance to water | AA | AA | A | AA | AA | AA | AA | AA |

Table 2 (following)—LEGEND

*1: Water dispersion liquid (containing resin dispersant) of carbon black, the numeral thereof in Table 2 indicates the pigment solid content amount;

*6: Self-dispersible carbon black, produced by Cabot Corporation, the numeral thereof in Table 2 indicates the pigment solid content amount;

*3: Produced by Nissin Chemical Industry Co. 5 Ltd., the numeral thereof in Table 2 indicates the active ingredient amount (solid content amount);

*7; Produced by Nissin Chemical Industry Co., Ltd.. the numeral thereof in Table 2 indicates the active ingredient amount (solid content amount);

*5: Produced by Nissin Chemical Industry Co., Ltd., the numeral thereof in Table 2 indicates the active ingredient amount;

*8: Potassium methacrylate, the numerals thereof in Table 2 each indicate a weight of methacrylic acid ions.

TABLE 2

| | | | | Comparative Example | | | | | | | |
|---|---|---|---|---|---|---|---|---|---|---|---|
| | | | | 1 | 2 | 3 | 4 | 5 | 6 | 7 | 8 |
| Ink | Colorant | Pigment dispersion liquid A (*1) | | 5.0 | 5.0 | 5.0 | 5.0 | 5.0 | 5.0 | — | 5.0 |
| com- | | CAB-O-JET (trade name) 300 (*6) | | — | — | — | — | — | — | 5.0 | — |
| posi- | Vinyl | | Tg | | | | | | | | |
| tion | chloride- | | (° C.) | | | | | | | | |
| (% by | acrylic | VINYBLAN | 73 | 5.0 | 5.0 | 5.0 | 5.0 | 5.0 | — | 5.0 | 5.0 |
| weight) | copolymer | (trade name) | | | | | | | | | |
| | emulsion | 701 (*3) | | | | | | | | | |
| | (E) | VINYBLAN | 25 | — | — | — | — | — | 5.0 | — | — |
| | | (trade name) | | | | | | | | | |
| | | 715S (*7) | | | | | | | | | |

| | | | | | | | | | |
|---|---|---|---|---|---|---|---|---|---|
| Humectant | Propylene glycol (P) | 25.0 | 25.0 | 25.0 | 25.0 | 25.0 | 25.0 | 25.0 | 25.0 |
| Penetrant | Triethylene glycol-n-butyl ether | 3.00 | 3.00 | 3.00 | 3.00 | 3.00 | 3.00 | 3.00 | 3.00 |
| Surfactant | Olfine (trade name) E1010 (*5) | 1.00 | 1.00 | 1.00 | 1.00 | 1.00 | 1.00 | 1.00 | 1.00 |
| Acid ion | Methacrylic acid ion (*8) | — | — | — | — | — | 0.05 | 0.05 | 0.005 |
| (A) | Acrylic acid ion | — | 0.05 | — | — | — | — | — | — |
| | Benzolic acid ion | — | — | 0.05 | — | — | — | — | — |
| | Fumaric acid ion | — | — | — | 0.05 | — | — | — | — |
| | Succinic acid ion | — | — | — | — | 0.05 | — | — | — |

| | | | | | | | | |
|---|---|---|---|---|---|---|---|---|
| Water | balance | balance | balance | balance | balance | balance | balance | balance |

| | | | | | | | | |
|---|---|---|---|---|---|---|---|---|
| A/E | 0 | 0.01 | 0.01 | 0.01 | 0.01 | 0.01 | 0.01 | 0.001 |
| P/E | 5 | 5 | 5 | 5 | 5 | 5 | 5 | 5 |
| Fixing performance to coated paper | C | C | C | C | C | C | C | C |
| Resistance to water | — | — | — | — | — | — | — | — |

As indicated in Table 1, in Examples 1 to 18, the evaluation results were satisfactory in relation to the fixing performance to the coated paper. Especially, in Examples 1 to 4 in which A/E=0.01 to 0.1 was satisfied, the evaluation results of the resistance to water were better than those of Examples 5 to 7 having the same conditions except for a condition in which A/E>0.1 was satisfied. Further, in Examples 9 to 12 in which P/E=2 to 7 was satisfied, the evaluation results of the resistance to water were better than that of Example 8 having the same conditions except for a condition in which P/E=1 was satisfied. In Examples 9 and 10 in which P/E=2 to 3 was satisfied, the evaluation results were especially satisfactory in relation to the fixing performance to the coated paper and the resistance to water. Further, in Examples 14 to 16 in which P/E=2 to 4 was satisfied, the evaluation results of the resistance to water were better than that of Example 13 having the same conditions except for a condition in which P/E=1 was satisfied. In Examples 14 and 15 in which P/E=2 to 3 was satisfied, the evaluation results were especially satisfactory in relation to the fixing performance to the coated paper and the resistance to water.

On the other hand, as indicated in Table 2, in Comparative Example 1 in which the methacrylic acid ions were not used and Comparative Examples 2 to 5 in which acrylic acid ions, benzoic acid ions, fumaric acid ions, and succinic acid ions were respectively used instead of the methacrylic acid ions, the evaluation results were bad in relation to the fixing performance to the coated paper. In Comparative Example 6 in which the vinyl chloride: acrylic copolymer emulsion having a glass transition temperature of less than 50° C. was used, the evaluation result was bad in relation to the fixing performance to the coated paper. In Comparative Example 7 in which only the self-dispersible pigment was used without using any resin-dispersed pigment, the evaluation result was bad in relation to the fixing performance to the coated paper. In Comparative Example 8 in which A/E<0.01 was satisfied, the evaluation result was bad in relation to the fixing performance to the coated paper.

As described above, the water-based ink of the present teaching can be fixed to the coated paper at a low temperature in a short time. The way of use of the water-based ink of the present teaching is not limited to the ink-jet recording on the coated paper. The water-based ink of the present teaching is widely applicable to the ink-jet recording on various kinds of recording mediums, such as regular paper, glossy paper, and mat paper.

What is claimed is:

1. A water-based ink for ink-jet recording, comprising:
a resin-dispersed pigment;
emulsion particles of a vinyl chloride-acrylic copolymer of which glass transition temperature is equal to or more than 50° C.;
methacrylic acid ions; and
water,
wherein a ratio (A/E) of a blending amount (A) of the methacrylic acid ions to a solid content blending amount (E) of the emulsion particles of the vinyl chloride-acrylic copolymer in the water-based ink is equal to or more than 0.01.

2. The water-based ink for ink-jet recording according to claim 1, wherein the ratio (A/E) of the blending amount (A) of the methacrylic acid ions to the solid content blending amount (E) of the emulsion particles of the vinyl chloride-acrylic copolymer in the water-based ink is in a range of 0.01 to 0.1.

3. The water-based ink for ink-jet recording according to claim 1, further containing propylene glycol,
wherein a ratio (P/E) of a blending amount (P) of the propylene glycol to the solid content blending amount (E) of the emulsion particles of the vinyl chloride-acrylic copolymer in the water-based ink is in a range of 2 to 7.

4. The water-based ink for ink-jet recording according to claim 1, further containing propylene glycol,
wherein a ratio (P/E) of a blending amount (P) of the propylene glycol to the solid content blending amount (E) of the emulsion particles of the vinyl chloride-acrylic copolymer in the water-based ink is in a range of 2 to 3.

5. The water-based ink for ink-jet recording according to claim 1, wherein the glass transition temperature of the vinyl chloride-acrylic copolymer is equal to or less than 200° C.

6. The water-based ink for ink-jet recording according to claim 1, wherein the glass transition temperature of the vinyl chloride-acrylic copolymer is in a range of 57 to 73° C.

7. The water-based ink for ink-jet recording according to claim 1, wherein the solid content blending amount of the emulsion particles of the vinyl chloride-acrylic copolymer in the water-based ink is in a range of 3 to 6% by weight.

8. The water-based ink for ink-jet recording according to claim 1, wherein the blending amount of the methacrylic acid ions in the water-based ink is in a range of 0.05 to 1.0% by weight.

9. The water-based ink for ink-jet recording according to claim 1, wherein the blending amount of the methacrylic acid ions in the water-based ink is in a range of 0.05 to 0.5% by weight.

10. The water-based ink for ink-jet recording according to claim 1, further comprising propylene glycol,
wherein the blending amount of the propylene glycol in the water-based ink is in a range of 5 to 35% by weight.

11. The water-based ink for ink-jet recording according to claim 1, further comprising propylene glycol,
wherein the blending amount of the propylene glycol in the water-based ink is in a range of 10 to 15% by weight.

12. The water-based ink for ink-jet recording according to claim 1, further containing potassium ions.

13. The water-based ink for ink-jet recording according to claim 1, further containing propylene glycol and triethylene glycol-n-butyl ether.

14. An ink-jet recording method, comprising:
performing recording by jetting the water-based ink according to claim 1 onto a recording medium in accordance with an ink-jet system, and
heating a portion recorded by use of the water-based ink on the recording medium at a temperature in a range of 0.2 to 4 times of the glass transition temperature of the vinyl chloride-acrylic copolymer to fix the water-based ink to the recording medium.

15. The ink-jet recording method according to claim 1wherein the recording medium is coated paper.

16. The ink-jet recording method according to claim 14, wherein the recording medium is heated at a temperature in a range of 50 to 100° C.
